(19) United States
(12) Patent Application Publication
(10) Pub. No.: US 2015/0141309 A1
(43) Pub. Date: May 21, 2015

(54) FABRIC SOFTENER COMPOSITION

(71) Applicant: The Procter & Gamble Company, Cincinnati, OH (US)

(72) Inventors: Dries VAES, Houtvenne (BE); Neil Andrew MACLEOD, Grimbergen (BE)

(21) Appl. No.: 14/534,204

(22) Filed: Nov. 6, 2014

Related U.S. Application Data
(60) Provisional application No. 61/904,465, filed on Nov. 15, 2013.

(51) Int. Cl. C11D 3/00; C11D 3/50

(52) U.S. Cl. CPC C11D 3/001; C11D 3/50
USPC 510/101; 510/516

(57) ABSTRACT

A fabric softener composition comprising a fabric softener active, a perfume oil, and from 0.4% to 0.9%, by weight of the composition, of an amphiphile compound. The fabric softener composition delivers improved physical stability across a broad temperature range without compromising its fabric softening properties.

### FIELD OF THE INVENTION

The present invention relates to a fabric softener composition and a process of making the fabric softener composition.

### BACKGROUND OF THE INVENTION

Conventional fabric softener compositions are added in the rinse cycle of the laundering process to soften fabrics. While pleasant fabric softness is the main motivation for users to use fabric softener compositions, good physical stability (i.e., a stable viscosity profile) is also desired. However, it is challenging to obtain a fabric softener composition that meets the user's fabric softness needs and that also remains physically stable across a broad temperature range, i.e., having a stable viscosity profile upon exposure to both lower temperature and higher temperature. Typically, when exposed to a relatively low temperature environment (e.g., below 0° C.), fabric softener compositions demonstrate an increase in viscosity, which may even exceed the maximum acceptable threshold. Without wishing to be bound by theory, it is believed that under such a low temperature environment, ice crystal formation destroys the vesicle structure of the fabric softener active, thereby leading to the increase in viscosity of the formulation.

Currently, one of the typical approaches to address the physical stability needs of fabric softener compositions is to incorporate polyols (e.g., glycerol). Such polyols prevent freezing and hence aid in the physical stability of fabric softener compositions. However, the polyols have to be present at a relatively high level of the composition (typically more than 5% and up to 50% by weight of the composition) to ensure product stability. In such formulations, the manufacture is forced to allocate a significant part of the formulation into the high levels of polyols, rather than invest in a more user relevant benefit for fabric softeners, such as fabric softener active or perfume.

An alternative approach to deliver the physical stability benefit is to use nonionic surfactants. However, nonionic surfactants have a negative impact on the physical stability at higher temperature and the stability over the shelf life at room temperature, albeit delivering acceptable physical stability at lower temperature. Without wishing to be bound by theory, it is believed that this negative impact on the physical stability is due to the interference of the nonionic surfactants with the vesicle structure of fabric softener actives. The vesicle structure of the actives is thus destroyed, leading to viscosity increase.

Thus, there is a need for a fabric softener composition that provides improved physical stability across a broad temperature range (i.e., at both lower temperature and higher temperature), without compromising its fabric softening properties. In particular, the present invention enables the use of a stabilizer at a relatively low level in the composition to deliver desirable physical stability.

It is an advantage of the present invention to provide a fabric softener composition having improved physical stability across a broad temperature range, as well as containing relatively high levels of fabric softener actives and perfume oils.

It is an extra advantage of the present invention to provide a process of making a fabric softener composition having improved physical stability across a broad temperature range.

### SUMMARY OF THE INVENTION

The present invention relates to a fabric softener composition, comprising:

a) a fabric softener active of a diester quaternary ammonium compound of formula (I):

{R₄₋ₘ—N+-[(CH₂)ₙ—Y—R⁵]ₘ}A- (I)
wherein each R is independently selected from the group consisting of hydrogen, a short chain C₁-C₆, poly(C₂₋₃ alkoxy), benzyl, and mixtures thereof; m is 2 or 3; each n is independently from 1 to 4; each Y is independently —O—(O)C— or —C(O)—O—; the sum of carbons in each R⁵ is C₁₁-C₂₁, with each R⁵ independently being a hydrocarbyl or substituted hydrocarbyl group; and A- is a softener-compatible anion;

b) from 0.4% to 0.9%, by weight of the fabric softener composition, of an amphiphile compound of formula (II):

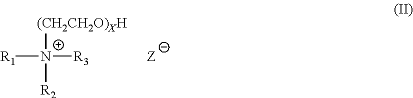

wherein R¹ is C₆-C₂₂ alkyl, branched or unbranched; R² is hydrogen, methyl, ethyl, or —(CH₂CH₂O)_{y}, wherein y is from 1 to 20; R³ is hydrogen, methyl, or ethyl; x is from 1 to 20; and Z is an anionic counterion; and

c) a perfume oil.

In another aspect, the present invention is directed to a process of making the fabric softener composition, comprising the steps of:

i) providing a fabric softener active composition comprising from 3% to 50%, by weight of the fabric softener active composition, of the fabric softener active;

ii) adding the perfume oil and the amphiphile compound separately to the fabric softener active composition,

thereby making the fabric softener composition.

In yet another aspect, the present invention is directed to a process of making the fabric softener composition, comprising the steps of:

i) providing a fabric softener active composition comprising from 3% to 50%, by weight of the fabric softener active composition, of the fabric softener active;

ii) mixing the perfume oil and the amphiphile compound to form a mixture; and

iii) adding the mixture obtained in step ii) to the fabric softener active composition,

thereby making the fabric softener composition.

### DETAILED DESCRIPTION OF THE INVENTION

In the present invention, it has been surprisingly found that the amphiphile compound, when incorporated at the specified level (from 0.4% to 0.9% by weight of the composition), helps maintain the physical stability of the fabric softener composition across a broad temperature range, without compromising the composition's fabric softening properties. In other words, the fabric softener composition of the present invention comprising the amphiphile compound at the specified level demonstrates a stable viscosity profile upon exposure to both lower temperature and higher temperature. In particular, the level of the amphiphile compound in the composition cannot be either too high (e.g., higher than 0.9% by weight of the composition) or too low (e.g., lower than 0.4% by weight of the composition). However, compared with conventional polyols that have to be present more than 5% by weight in the composition to ensure product stability, the amphiphile compound of the present invention requires a relatively low level in the composition. Accordingly, the present invention provides for cost-effective manufacturing and market flexibility. Since the product is suitable for both cold and warm climates/seasons, the present invention minimizes the need for climate control during manufacturing, shipping, and storage.

Moreover, by incorporating the amphiphile compound at the specified level, the fabric softener composition of the present invention allows for the presence of fabric softener actives and/or perfume oils at even higher levels, thereby providing improved fabric softening or freshness properties, without causing a stability concern across a broad temperature range.

### DEFINITIONS

As used herein, the term “fabric softener composition” means a composition that delivers a fabric softening benefit to fabrics. In addition to the fabric softening benefit, fabric softener compositions may be able to deliver one or more of the following benefits to fabrics as well: fabric freshness, fabric lubrication, fabric relaxation, wrinkle resistance, wrinkle reduction, durable press, ease of ironing, abrasion resistance, fabric smoothing, anti-felting, anti-pilling, crispness, appearance enhancement, appearance rejuvenation, color protection, color rejuvenation, anti-shrinkage, in-wear shape retention, fabric elasticity, fabric tensile strength, fabric tear strength, static reduction, water absorbency or repellency, stain repellency, refreshing, anti-microbial, odor resistance, and mixtures thereof. The fabric softener compositions include various tablet, granular, liquid and rinse-aids, sprays and mists, and substrate-laden types for fabrics; as well as substrate-laden products such as dryer added sheets, dry and wetted wipes and pads, and nonwoven substrates.

As used herein, the term “fabric softener active composition” means a composition that constitutes the main part of a fabric softener composition. The fabric softener active composition generally comprises a fabric softener active, which delivers the intended function of softening fabrics.

As used herein, the term “perfume oil” refers to free, volatile oils comprising one or more perfume raw materials (PRMs) and optional solvents, in which no chemical compounds are intentionally added to combine or react with the PRMs, and therefore the PRMs are free to become volatized and available for olfactory detection by a user. The term “perfume delivery system”, as used herein refers to the combination or reaction product of PRMs with certain chemical compounds, which enhances the deposition efficiency of the perfume onto fabrics and/or a controlled release of the perfume. For example, sulfur-containing pro-perfume compound and perfume microcapsule (PMC) are two types of the perfume delivery system. The term “perfume” herein is a general term that could refer to PRM, perfume delivery system, perfume oil, or a pleasant scent achieved thereby.

As used herein, the term “alkyl” means a hydrocarbyl moiety which is branched or unbranched, saturated or unsaturated. Included in the term “alkyl” is the alkyl portion of acyl groups.

As used herein, the term “physical stability” means maintenance of commercially acceptable viscosity. In the context of the present invention, a commercially acceptable viscosity value is below 300 cps at a shear rate of 1/sec.

As used herein, the term “lower temperature” means temperatures below 10° C., preferably below 0° C., and the term “higher temperature” means temperatures above 30° C., preferably above 35° C.

As used herein, the articles including “a” and “an” when used in a claim, are understood to mean one or more of what is claimed or described.

As used herein, the terms “comprise” “comprises” “comprising” “include”, “includes”, and “including” are meant to be non-limiting, i.e., other steps and other ingredients which do not affect the end of result can be added. The above terms encompass the terms “consisting of” and “consisting essentially of”.

### Fabric Softener Composition

The fabric softener composition of the present invention comprises a fabric softener active of a diester quaternary ammonium compound, from about 0.4% to 0.9% by weight of the fabric softener composition of an amphiphile compound, and a perfume oil. Preferably, the fabric softener composition further comprises one or more adjunct materials.

The fabric softener composition herein is preferably in a liquid form. The liquid fabric softener composition may be packaged in a container (preferably containing multiple doses) or encapsulated within a water-soluble film as a unit dose. The liquid composition may be aqueous or non-aqueous, but preferably is aqueous. Where the composition is aqueous, it comprises water from 2% to 95%, preferably from 30% to 90%, more preferably from 50% to 80%, by weight of the composition. In the liquid execution, the fabric softener composition preferably has a pH range of from 2 to 4, preferably from 2.5 to 3.5, measured at ambient temperature.

As mentioned above, due to the incorporation of the amphiphile compound at the specified level, the fabric softener composition of the present invention delivers commercially acceptable viscosity at both lower temperature and higher temperature. In one embodiment, the composition is in a liquid form and has a viscosity value below 300 cps, preferably from 10 to 300 cps, more preferably from 50 to 250 cps, even more preferably from 75 to 200 cps, at a shear rate of 1/sec and at 25° C.

### Amphiphile Compound

The fabric softener composition of the present invention comprises from 0.4% to 0.9%, by weight of the fabric softener composition, of an amphiphile compound of formula (II):

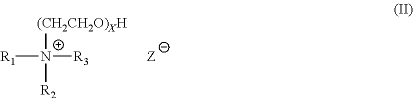

wherein R¹ is C₆-C₂₂ alkyl, branched or unbranched; R² is hydrogen, methyl, ethyl, or —(CH₂CH₂O)_{y}, wherein y is from 1 to 20; R³ is hydrogen, methyl, or ethyl; x is from 1 to 20; and Z is an anionic counterion, preferably selected from chloride, bromide, methylsulfate, ethylsulfate, sulfate, or nitrate.

Preferably, in formula (II), R₁ is C₆ to C₁₈ alkyl, branched or unbranched; R₂ is —(CH₂CH₂O)_{y}, wherein y is from 2 to 10; R₃ is methyl; X is from 2 to 10; and Z is chloride.

Most preferably, the amphiphile compound is a C₁₂ alkyl bis(hydroxyethyl) methyl ammonium chloride, wherein the C₁₂ alkyl chain is derived from a coconut oil. An example of C₁₂ alkyl bis(hydroxyethyl) methyl ammonium chloride is Variquat® K-1215 commercially available from Evonik located in Essen, Germany.

The amphiphile compound is present in the fabric softener composition, from 0.4% to 0.9%, preferably from 0.5% to 0.9%, more preferably from 0.5% to 0.8%, by weight of the fabric softener composition.

### Fabric Softener Active

The fabric softener composition of the present invention comprises a fabric softener active of a diester quaternary ammonium compound of formula (I):

{R₄₋ₘ—N+-[(CH₂)ₙ—Y—R⁵]ₘ}A- (I)

wherein each R is independently selected from the group consisting of hydrogen, a short chain C₁-C₆, poly(C₂-C₃ alkoxy), benzyl, and mixtures thereof; m is 2 or 3; each n is independently from 1 to 4; each Y is independently —O—(O)C— or —C(O)—O—; the sum of carbons in each R⁵ is C₁₁-C₂₁, with each R⁵ independently being a hydrocarbyl or substituted hydrocarbyl group; and A- is a softener-compatible anion.

Preferably, in formula (I), each R is independently selected from a C₁-C₃ alkyl; m is 2; each n is independently from 1 to 2; each is independently —O—(O)C— or —C(O)—O—; the sum of carbons in each R⁵ is C₁₂-C₂₀, with each R⁵ independently being a hydrocarbyl or substituted hydrocarbyl group; and A- is selected from chloride, bromide, methylsulfate, ethylsulfate, sulfate, or nitrate. More preferably, the fabric softener active is a bis-(2-hydroxyethyl)-dimethylammonium chloride fatty acid ester, preferably having an average chain length of the fatty acid moieties of from 16 to 20 carbon atoms, preferably from 16 to 18 carbon atoms.

The fabric softener active may be present at any suitable level, preferably at a relatively high level (e.g., above 8% by weight of the fabric softener composition) in the fabric softener composition. In one embodiment, the fabric softener active is present from 3% to 15%, preferably from 5% to 12%, more preferably from 7% to 11%, by weight of the fabric softener composition. The presence of a relatively high level of the fabric softener active in the fabric softener composition typically poses stability challenges to formulators in the art. However, in the present invention, the applicant has surprisingly found that the incorporation of the amphiphile compound at the specified level delivers improved physical stability to a fabric softener composition, even in the presence of a relatively high level of the fabric softener active. Thus, in the present invention, the amphiphile compound allows for a fabric softener composition that provides improved physical stability as well as good softening properties.

In one embodiment, the fabric softener composition herein comprises a weight ratio of fabric softener active to amphiphile compound of at least 3:1, alternatively 4:1, or 5:1, or 6:1, or 10:1, alternatively not greater than 30:1.

In one embodiment, the fabric softener active is contained in a fabric softener active composition before combining with other ingredients to make the fabric softener composition. Preferably, the fabric softener active composition comprises from 3% to 50%, preferably from 6% to 25%, more preferably from 7% to 18%, even more preferably from 9% to 15%, by weight of the fabric softener active composition, of the fabric softener active. In addition to the fabric softener active, the fabric softener active composition preferably comprises other materials, non-limiting examples of which include water, salt (e.g., CaCl₂), acid (e.g., HCl and formic acid), and preservative.

### Perfume Oil

The fabric softener composition of the present invention comprises a perfume oil. The perfume oil may be present at any suitable level, preferably at a relatively high level (e.g., above 1% by weight of the fabric softener composition) in the fabric softener composition. In one embodiment, the perfume oil is present from 0.5% to 5%, preferably from 1% to 4%, more preferably from 2% to 3.5%, by weight of the fabric softener composition. Similar to the fabric softener active, formulating a relatively high level of the perfume oil in the fabric softener composition also poses stability challenges. However, in the present invention, it has been surprisingly found that the incorporation of the amphiphile compound at the specified level delivers improved physical stability to a fabric softener composition, in the presence of a relatively high level of the perfume oil. Thus, in the present invention, the amphiphile compound allows for a fabric softener composition that provides improved physical stability as well as good freshness properties.

In one embodiment, the fabric softener composition herein comprises a weight ratio of perfume oil to amphiphile compound of at least 1:1, alternatively 2:1, or 3:1, or 4:1, or 5:1, alternatively not greater than 20:1.

Perfume oils are typically mixtures of polar and non-polar oils. A composition comprising oils, even when some of these oils are polar, is not easily dispersed in a water continuous composition such as a fabric softener composition. Without wishing to be bound by theory, but a perfume must be finely subdivided in the continuous water phase of a fabric softening composition to enable adsorption of the perfume by the dispersed lamellar phase(s).

One generally predicative measure of a perfume oil's dispersibility in water continuous compositions may include the perfume dielectronic constant. PRMs with a lower dielectric constant, or the less polar PRMs, are more likely to be difficult to incorporate into fabric softener compositions comprising dispersed lamellar phases because such perfumes are more cohesive in an aqueous environment and thus require more mechanical energy to be subdivided in this environment. In one embodiment, the perfume oil of the present invention may have a combined dielectric constant below 12, or 11, or 10, or 9, or 8, or 6, or 5, or 4, alternatively greater than 1. The dielectronic constant can be measured by a Dielectric Constant Meter model 870, which is commercially available from Scientifica.

Another generally predictive measure of a perfume oil's dispersibility in water continuous compositions may include a PRM's Log P that is the PRM's partition coefficient between water and octanol. One way of measuring Log P of a PRM is using the “ClogP” program from BioByte Corp (latest version). Another suitable way of measuring Log P is using the ClogP program from Daylight Chemical Information Systems, Inc. of Aliso Viejo, Calif., USA (latest version). Without wishing to be bound by theory, the higher a PRM's Log P, the higher the ingredient's hydrophobicity, and the more difficult, e.g., more chemical energy required, it is to incorporate the PRM in a fabric softener composition. A non-limiting set of PRMs are disclosed in U.S. Pat. No. 5,500,138, from column 7 line 42 to column 11 line 44. In one embodiment, more than 25% of the PRMs by weight of the perfume oil have a Log P higher than 2.5. Preferred embodiments include more than 35%, or more than 45%, or more than 50%, or more than 60%, or more than 70%, or more than 75% of PRMs by weight of the perfume oil have a Log P higher than 2.5.

In one embodiment, the perfume oil comprises at least 1, 2, 3, 4, 5, 6, 7, 8, 9, 10, 11, 12, or alternatively not greater than 100, different individual PRMs.

In one preferred embodiment, the perfume oil comprises a PRM selected from the group consisting of alpha-damascone, delta-damascone, iso-damascone, carvone, gamma-methyl-ionone, beta-ionone, iso-e-super, 2,4,4,7-tetramethyl-oct-6-en-3-one, benzyl acetone, beta-damascone, damascenone, methyl dihydrojasmonate, methyl cedrylone, hedione, floralozone, citral, 1-decanal, benzaldehyde, florhydral, 2,4-dimethyl-3-cyclohexen-1-carboxaldehyde, cis/trans-3,7-dimethyl-2,6-octadien-1-al, heliotropin, 2,4,6-trimethyl-3-cyclohexene-1-carboxaldehyde, 2,6-nonadienal, alpha-n-amyl cinnamic aldehyde, alpha-n-hexyl cinnamic aldehyde, p-t-bucinal, lyral, cymal, methyl nonyl acetaldehyde, trans-2-nonenal, lilial, trans-2-nonenal, datilat, anisic aldehyde, geranial, i-octanal, helional, cuminaldehyde, triplal, melonal, and a combination thereof. Most preferably, the perfume oil comprises delta-damascone.

In one embodiment, the perfume oil is not pre-emulsified, i.e., prior to being added into the fabric softener active composition, the perfume oil is not mixed with other liquids that are normally immiscible with the perfume, e.g., an emulsifier. In an alternative embodiment, the perfume oil is emulsified before being added to the fabric softener active composition.

### Adjunct Ingredients

The fabric softener composition preferably comprises one or more adjunct materials. The adjunct materials herein may include: a perfume delivery system (e.g., a sulfur-containing pro-perfume compound, a perfume microcapsule (PMC)), rheology modifier (e.g., Rheovis® available from BASF), stabilizer, pH control agent, metal ion control agent, colorant, brightener, dye, solvent (e.g., polyols), soil release polymer, preservative (e.g., Proxel® GXL available from Arch Chemicals, Inc.), antimicrobial agent, chlorine scavenger, enzyme, anti-shrinkage agent, fabric crisping agent, silicone (e.g., polydimethyl silicone (PDMS)), spotting agent, anti-oxidant, anti-corrosion agent, bodying agent, drape and form control agent, smoothness agent, static control agent, wrinkle control agent, sanitization agent, disinfecting agent, germ control agent, mold control agent, mildew control agent, antiviral agent, anti-microbial, drying agent, stain resistance agent, soil release agent, malodor control agent, fabric refreshing agent, chlorine bleach odor control agent, dye fixative, dye transfer inhibitor, color maintenance agent, color restoration/rejuvenation agent, anti-fading agent, whiteness enhancer, anti-abrasion agent, wear resistance agent, fabric integrity agent, anti-wear agent, and rinse aid, UV protection agent, sun fade inhibitor, insect repellent, anti-allergenic agent, enzyme, flame retardant, water proofing agent, fabric comfort agent, water conditioning agent, shrinkage resistance agent, stretch resistance agent, enzymes, cationic starch, and mixtures thereof. In one preferred embodiment, the fabric softener composition further comprises an adjunct ingredient selected from the group consisting of a sulfur-containing pro-perfume compound, a PMC, a solvent (e.g., a polyol), a rheology modifier, and a combination thereof.

Perfume Delivery System

The fabric softener composition herein may comprise one or more types of perfume delivery systems. Non-limiting examples of the perfume delivery systems suitable for use herein include the following: non-surfur-containing pro-perfume compound, PMC, cyclodextrin, zeolite & inorganic carrier, starch encapsulated accord, amine-assisted perfume delivery system (AAD), and polyacrylate capsule. Descriptions on these perfume delivery systems can be found in US Patent Publication No. 2007/0275866 from paragraphs [0025] to [0030].

In one embodiment, the fabric softener composition herein further comprises a surfur-containing pro-perfume compound. The term “sulfur-containing pro-perfume compound” herein refers to a type of pro-perfume compound that contains sulfur. The term “pro-perfume compound” herein refers to compounds resulting from the reaction of PRMs with other chemicals, which have a covalent bond between one or more PRMs and these other chemicals. The PRM is converted into a new material called a pro-perfume compound, which then may release the original PRM (i.e., pre-converted) upon exposure to a trigger such as water or light or atmospheric oxygen. Suitable pro-perfume compounds and methods of making the same can be found in U.S. Pat. Nos. 7,018,978; 6,861,402; 6,544,945; 6,093,691; 6,165,953; and 6,096,918. Suitable sulfur-containing pro-perfume compounds and methods of making the same can be found in WO Publication No. 2012/113746.

Preferably, the sulfur-containing pro-perfume compound is selected from the group consisting of methyl or ethyl 2-(4-oxo-4-(2,6,6-trimethylcyclohex-3-en-1-yl)butan-2-ylamino)-3-(4-oxo-4-(2,6,6-trimethylcyclohex-3-en-1-yl)butan-2-ylthio)propanate, methyl or ethyl 2-(4-oxo-4-(2,6,6-trimethylcyclohex-2-en-1-yl)butan-2-ylamino)-3-(4-oxo-4-(2,6,6-trimethylcyclohex-2-en-1-yl)butan-2-ylthio)propanate, methyl or ethyl 2-(2-oxo-4-(2,6,6-trimethylcyclohex-1-en-1-yl)butan-4-ylamino)-3-(2-oxo-4-(2,6,6-trimethylcyclohex-1-en-1-yl)butan-4-ylthio)propanate, methyl or ethyl 2-(2-oxo-4-(2,6,6-trimethylcyclohex-2-en-1-yl)butan-4-ylamino)-3-(2-oxo-4-(2,6,6-trimethylcyclohex-2-en-1-yl)butan-4-ylthio)propanate, 3-(dodecylthio)-1-(2,6,6-trimethylcyclohex-3-en-1-yl)-1-butanone, 3-(dodecylthio)-1-(2,6,6-trimethylcyclohex-2-en-1-yl)-1-butanone, 4-(dodecylthio)-4-(2,6,6-trimethylcyclohex-2-en-1-yl)-2-butanone, 4-(dodecylthio)-4-(2,6,6-trimethylcyclohex-1-en-1-yl)-2-butanone, 2-dodecylsulfanyl-5-methyl-heptan-4-one, 2-cyclohexyl-1-dodecylsulfanyl-hept-6-en-3-one, 3-(dodecylthio)-5-isopropenyl-2-methylcyclohexanone, and a combination thereof. More preferably, the sulfur-containing pro-perfume compound is selected from the group consisting of 3-(dodecylthio)-1-(2,6,6-trimethylcyclohex-3-en-1-yl)-1-butanone, 4-(dodecylthio)-4-(2,6,6-trimethylcyclohex-2-en1-yl)-2-butanone, 4-(dodecylthio)-4-(2,6,6-trimethylcyclohex-1-en-1-yl)-2-butanone and 3-(dodecylthio)-5-isopropenyl-2-methylcyclohexanone, and a combination thereof. 3-(dodecylthio)-1-(2,6,6-trimethylcyclohex-3-en-1-yl)-1-butanone is the most preferred sulfur-containing pro-perfume compound, such as Haloscent® D available from Firmenich located in Geneva, Switzerland.

The sulfur-containing pro-perfume compound can be present at any suitable level in the fabric softener composition. Preferably, the sulfur-containing pro-perfume compound is present at least 0.0001%, alternatively from 0.0001% to 5%, alternatively from 0.001% to 4%, alternatively from 0.01% to 3%, alternatively from 0.05% to 2%, alternatively from 0.08% to 1%, alternatively combinations thereof, by weight of the composition.

In another embodiment, the fabric softener composition further comprises a PMC, preferably a friable PMC. The PMC comprises a wall material and a core material of PRM that is encapsulated within the wall material. The PRM is not being released from the PMC until the wall material ruptures because of a mechanical stress (e.g., friction), i.e., the perfume release from the PMC is at different time points from the required perfume oil and sulfur-containing pro-perfume compound. PMCs are described in the following references: US 2003/215417 A1; US 2003/216488 A1; US 2003/158344 A1; US 2003/165692 A1; US 2004/071742 A1; US 2004/071746 A1; US 2004/072719 A1; US 2004/072720 A1; EP 1,393,706 A1; US 2003/203829 A1; US 2003/195133 A1; US 2004/087477 A1; US 2004/0106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; US RE 32,713; U.S. Pat. No. 4,234,627. PMCs may be prepared using a range of conventional methods known to those skilled in the art for making shell capsules, such as Interfacial polymerization, and polycondensation. See e.g., U.S. Pat. No. 3,516,941, U.S. Pat. No. 4,520,142, U.S. Pat. No. 4,528,226, U.S. Pat. No. 4,681,806, U.S. Pat. No. 4,145,184; GB 2,073,132; WO 99/17871; and MICROENCAPSULATION: Methods and Industrial Applications Edited by Benita and Simon (Marcel Dekker, Inc. 1996). It is recognized, however, that many variations with regard to materials and process steps are possible. Non-limiting examples of materials suitable for making shell of the microcapsule include urea-formaldehyde, melamine-formaldehyde, phenol-formaldehyde, gelatin, polyurethane, polyamides.

Suppliers of PMCs may include International Flavors & Fragrances (IFF), Reed Pacific, and Appleton. An example of a suitable PMC for purposes of the present invention includes perfume microcapsules from Appleton. Other examples may include WIZARD from Reed Pacific, and EVERLAST from IFF.

The PMC can be present at any suitable level in the fabric softener composition. Preferably, the PMC is present at least 0.1%, alternatively from 0.1% to 5%, alternatively from 0.2% to 4%, alternatively from 0.3% to 3%, alternatively from 0.4% to 1%, alternatively combinations thereof, by weight of the composition.

In yet another embodiment, the fabric softener composition further comprises a surfur-containing pro-perfume compound and a PMC. The levels of these perfume delivery systems in the fabric softener composition will depend on factors like the specific type of the composition. Preferably, when present, the total levels of these perfume delivery systems in the fabric softener composition are at least 0.0001%, alternatively from 0.0001% to 10%, alternatively from 0.001% to 5%, alternatively from 0.1% to 3%, alternatively combinations thereof, by weight of the composition.

Polyol

The fabric softener composition herein may comprise a polyol. The term “polyol” herein refers to a polyhydric alcohol. Such polyols aid in the physical stability of fabric softener compositions as aforementioned and also function as a solvent. The polyol is preferably selected from the group consisting of glycerol, di-propylene glycol, mono-propylene glycol, pentaerythritol, hexyleneglycol, glucose, sorbitol, sucrose, maltose, and combinations thereof. More preferably, the polyol is selected from the group consisting of glycerol, di-propylene glycol, mono-propylene glycol, and combinations thereof. Most preferably, the polyol is glycerol.

The polyol may be present at any suitable level in the fabric softener composition. In particular, due to the presence of the amphiphile compound that delivers physical stability, the polyol (if present) does not have to be at a relatively high level, as required in the art. Without wishing to be bound by theory, it is believed that the combination of the amphiphile compound and the polyol (e.g., glycerol) in the fabric softener composition delivers even better physical stability. In one embodiment, the polyol level is present from 0.1% to 10%, alternatively from 1% to 8%, alternatively from 3% to 7%, alternatively from 4% to 5%, alternatively combinations thereof, by weight of the fabric softener composition.

Rheology Modifier

The fabric softener composition herein may comprise a rheology modifier that renders desired viscosity to the composition. Also, the rheology modifier functions as a structurant to sustain certain solid ingredients in the composition (e.g., PMCs). Suitable levels of the rheology modifier herein are in the range of from 0.001% to 10%, alternatively from 0.01% to 1%, alternatively from 0.1% to 0.5%, alternatively from 0.2% to 0.4%, alternatively combinations thereof, by weight of the fabric softener composition.

In one embodiment, the rheology modifier suitable for use herein can be selected from thickening stabilizers. These include gums and other similar polysaccharides, for example gellan gum, carrageenan gum, xanthan gum, Diutan gum (available from CP Kelco), and other known types of thickeners and rheological additives such as Rheovis® CDP (available from BASF), Alcogum® L-520 (available from Alco Chemical), and Sepigel 305 (available from SEPPIC).

In another embodiment, cationic acrylic-based polymers are utilized as the rheology modifier herein. One example of such rheology modifier is poly(acrylic acid). Another example is cationic acrylic based polymer, sold under the name Rheovis® CDE by BASF.

In a highly preferred embodiment, the fabric softener composition of the present invention comprises:

a) from 8% to 11%, by weight of the fabric softener composition, of a bis-(2-hydroxyethyl)-dimethylammonium chloride fatty acid ester;

b) from 0.5% to 0.9%, by weight of the fabric softener composition, of a amphiphile compound of formula (I):

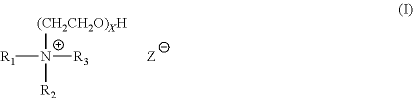

wherein R¹ is C₆-C₂₂ alkyl, branched or unbranched; R² is hydrogen, methyl, ethyl, or —(CH₂CH₂O)_{y}, wherein y is from 1 to 20; R³ is hydrogen, methyl, or ethyl; x is from 1 to 20; and Z is an anionic counterion; and

c) from 3% to 3.5%, by weight of the fabric softener composition, of a perfume oil.

Even more preferably, the fabric softener composition further comprises:

d) from 0.01% to 3%, by weight of the fabric softener composition, of 3-(dodecylthio)-5-isopropenyl-2-methylcyclohexanone;

e) from 0.1% to 5%, by weight of the fabric softener composition, of a PMC;

f) from 3% to 7%, by weight of the fabric softener composition, of a glycerol; and

g) from 0.01% to 1%, by weight of the fabric softener composition, of a poly(acrylic acid).

### Composition Preparation

The fabric softener composition of the present invention is generally prepared by conventional methods such as those known in the art of making fabric softener compositions. Such methods typically involve mixing the essential and optional ingredients in any desired order to a relatively uniform state, with or without heating, cooling, application of vacuum, and the like, thereby providing liquid detergent compositions containing ingredients in the requisite concentrations.

The process herein could be a batch process or an in-line process. Preferably, the process is in-line. The fabric softener active composition that constitutes the main portion of a final composition flows through a line, and other ingredients including the amphiphile compound, the perfume oil, and optionally the adjunct ingredients are added into the flow, to form the final fabric softener composition. Such an in-line process is described in the following references: US Patent Publication No. 2008/0031084 and No. 2008/0031085.

In one embodiment, the fabric softener composition is made according to a process comprising the steps of:
i) providing a fabric softener active composition comprising from 3% to 50%, by weight of the fabric softener active composition, of the fabric softener active;
ii) mixing the perfume oil and the amphiphile compound to form a mixture; and
iii) adding the mixture obtained in step i) to the fabric softener active composition, thereby making the fabric softener composition.

In an alternative embodiment, the fabric softener composition is made according to a process comprising the steps of:

i) providing a fabric softener active composition comprising from 3% to 50%, by weight of the fabric softener active composition, of the fabric softener active;

ii) adding the perfume oil and the amphiphile compound separately to the fabric softener active composition,

thereby making the fabric softener composition.

In the separate addition execution, the amphiphile compound and the perfume oil are preferably added to the fabric softener active composition via separate injections. More preferably, the separate injections for adding the amphiphile compound and the perfume oil are installed in an in-line process.

In one embodiment, one or more adjunct ingredients are added after step ii). Preferably, the one or more adjunct ingredients are added via an injection that is separate from the injection used to add the amphiphile compound or the perfume oil. Even more preferably, each of the adjunct materials is added via separate injections.

### Method for Determining of Physical Stability for Liquid Compositions

A. Sample Preparation

One hundred and seventy-five (175) ml of test composition is put in a glass jar of 210 ml and closed with a metal lid.

B. Low temperature cycle

The glass jar containing the test composition is put in a Sanyo MIR-154 cabinet, which is programmed with a low temperature cycle as specified in Table 1. The glass jar is put into the cabinet between 8:00 and 10:00, and then stored in the cabinet for 24 hours. After removing the glass jar from the cabinet, the glass jar is stored at 25° C. for 24 hours.

TABLE 1

| Time | Temperature | |
|---|---|---|
| 0:00 | 0.0° | C. |
| 11:00 | −1.3° | C. |
| 12:00 | −2.5° | C. |
| 13:00 | −3.8° | C. |
| 14:00 | −5.0° | C. |
| 15:00 | −6.3° | C. |
| 16:00 | −7.5° | C. |
| 17:00 | −8.8° | C. |
| 18:00 | −10.0° | C. |
| 22:00 | −10.0° | C. |
| 23:00 | −5.0° | C. |
| 0:00 | 0.0° | C. |

C. Viscosity measurement

The viscosity of the sample is measured at two time points: before and after the sample is exposed to the low temperature cycle. Specifically, the viscosity is measured 1) when the sample is freshly made and before it is exposed to the low temperature cycle (after step A. Sample preparation), and 2) after the sample is exposed to the low temperature cycle and stored at 25° C. for 24 hours (after step B. Low temperature cycle). Three replicates are analyzed for each sample.

The viscosity herein is measured using a Brookfield DV-E viscometer (Brookfield Engineering, Middleboro Mass., USA), with spindle #62. The shear rate is held constant at a shear rate of 1/sec, until steady state is achieved, then the viscosity is measured. All measurements were done at 25° C.

### EXAMPLES

The Examples herein are meant to exemplify the present invention but is not used to limit or otherwise define the scope of the present invention. Examples 1A-1F are illustrative of the present invention, while Examples 2A-2C are comparative examples.

### Example 1

### Formulations of Fabric Softener Compositions

The following fabric softener compositions shown in Table 2 are made comprising the listed ingredients in the listed proportions (weight %).

TABLE 2

| | 1A | 1B | 1C | 1D | 1E | 1F |
|---|---|---|---|---|---|---|
| Bis-(2-hydroxyethyl)- | 9.5 | 9.5 | 9.5 | 9.5 | 9.5 | 9.5 |
| dimethylammonium | | | | | | |
| chloride fatty acid ester | | | | | | |
| Variquat ® a | 0.5 | 0.58 | 0.75 | 0.88 | 0.5 | 0.75 |
| Perfume oil | 3 | 3.5 | 3 | 3.5 | 3 | 3.5 |
| Sulfur-containing pro- | 0 | 0 | 0.05 | 0 | 0 | 0 |
| perfume compound b | | | | | | |
| Rheovis ® CDE c | 0.4 | 0.3 | 0.4 | 0.3 | 0.2 | 0 |
| PMC | 0.5 | 0.35 | 0.5 | 0.35 | 0 | 0 |
| Glycerol | 5 | 5 | 5 | 5 | 0 | 2 |
| Dye | 0.001 | 0 | 0.001 | 0 | 0.001 | 0 |
| Water | Add to 100 | Add to 100 | Add to 100 | Add to 100 | Add to 100 | Add to 100 |

a Variquat ® K-1215 is C₁₂ alkyl bis(hydroxyethyl) methyl ammonium chloride acting as an amphiphile compound, available from Evonic
b 3-(dodecylthio)-1-(2,6,6-trimethylcyclohexen-3-en-1-yl)-1-butanone, available from Firmenich
c Rheovis ® CDE is cationic acrylic based polymer acting as a rheology modifier available from BASF

### Preparation of the compositions of Examples 1A-1F

The compositions of Examples 1A-1F are prepared by the following steps:

a) providing a fabric softener active composition comprising 9.5% by weight of a bis-(2-hydroxyethyl)-dimethylammonium chloride fatty acid ester;

b) mixing Variquat® K-1215, perfume oil, and sulfur-containing pro-perfume compound (if any) to form a mixture;

c) adding the mixture obtained in step b), Rheovis® (if any), glycerol (if any), PMC (if any), dye (if any), and water separately to the fabric softener active composition; and

d) mixing the combination obtained in step c) by applying a shear of 15000 s⁻¹, thereby making the fabric softener composition,

wherein each ingredient in the composition is present in the amount as specified for Examples 1A-1F in Table 2.

### Comparative Example 2

### Comparative Formulations of Fabric Softener Compositions

The following comparative fabric softener compositions shown in Table 3 are made comprising the listed ingredients in the listed proportions (weight %).

TABLE 3

| | 2A | 2B | 2C |
|---|---|---|---|
| Bis-(2-hydroxyethyl)- | 9.5 | 9.5 | 9.5 |
| dimethylammonium | | | |
| chloride fatty acid ester | | | |
| Variquat ® a | 0 | 1 | 1.2 |
| Perfume oil | 3.5 | 3 | 3.5 |
| Sulfur-containing pro-perfume | 0 | 0.05 | 0 |
| compound b | | | |
| Rheovis ® CDE c | 0.3 | 0.4 | 0.3 |
| PMC | 0.35 | 0.5 | 0.35 |
| Glycerol | 5 | 5 | 5 |
| Dye | 0 | 0.001 | 0 |
| Water | Add to 100 | Add to 100 | Add to 100 |

^{a}Variquat ® K-1215 is C₁₂ alkyl bis(hydroxyethyl) methyl ammonium chloride acting as an amphiphile compound, available from Evonic
^{b}3-(dodecylthio)-1-(2,6,6-trimethylcyclohexen-3-en-1-yl)-1-butanone, available from Firmenich
^{c}Rheovis ® CDE is cationic acrylic based polymer acting as a rheology modifier available from BASF

### Preparation of the compositions of Comparative Examples 2A-2C

The process of making the fabric softener compositions of Comparative Examples 2A-2C is the same as in Example 1, except for the following: each ingredient in the composition is present in the amount as specified for Examples 2A-2C in Table 3.

### Comparative data of Examples 1-2

Comparative experiments of assessing the physical stability of the fabric softener compositions (i.e., viscosity of the compositions before and after the low temperature cycle) of Examples 1A-1D and Comparative Examples 2A-2C, are conducted. Specifically, the viscosity of the fabric softener compositions is measured at a shear rate of 10/sec and a temperature of 25° C., according to the viscosity test method as described herein above. The viscosity values of the compositions are shown in Table 4.

TABLE 4

| Viscosity | 1A | 1B | 1C | 1D | 2A | 2B | 2C |
|---|---|---|---|---|---|---|---|
| before the low | 215 | 138 | 196 | 109 | 249 | 166 | 102 |
| temperature cycle/cps | | | | | | | |
| after the low | 239 | 136 | 275 | 120 | 256 | 546 | 404 |
| temperature cycle/cps | | | | | | | |

As shown in Table 4, all of the fabric softener compositions according to the present invention (Examples 1A-1D) demonstrate an improved viscosity profile across a broad temperature range (e.g., at both −10° C. and 25° C.), particularly after being exposed to a low temperature cycle, over the comparative compositions (Comparative Examples 2A-2C).

Moreover, it is worth noting that the levels of the fabric softener active (bis-(2-hydroxyethyl)-dimethylammonium chloride fatty acid ester) and perfume oil in these compositions are relatively high (9.5% by weight and 3% or 3.5% by weight, respectively). Such high levels of the fabric softener active and perfume oil typically cause a stability issue in the art, as shown in Comparative Examples 2A-2C.

Unless otherwise indicated, all percentages, ratios, and proportions are calculated based on weight of the total composition. All temperatures are in degrees Celsius (° C.) unless otherwise indicated. All component or composition levels are in reference to the active level of that component or composition, and are exclusive of impurities, for example, residual solvents or by-products, which may be present in commercially available sources.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein. Although the ranges throughout the application are paired as particular upper and lower numerical limitations, they may be interchangeably utilized based on different embodiments so long as the range limits apply to the same ingredient.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric softener composition comprising:
a) a fabric softener active of a diester quaternary ammonium compound of formula (I):
{R₄₋ₘ—N+-[(CH₂)ₙ—Y—R⁵]ₘ}A- (I)
wherein each R is independently selected from the group consisting of hydrogen, a short chain C₁-C₆, poly(C₂-C₃ alkoxy), benzyl, and mixtures thereof; m is 2 or 3; each n is independently from 1 to 4; each Y is independently —O—(O)C— or —C(O)—O—; the sum of carbons in each R⁵ is C₁₁-C₂₁, with each R⁵ independently being a hydrocarbyl or substituted hydrocarbyl group; and A- is a softener-compatible anion;
b) from about 0.4% to about 0.9%, by weight of the fabric softener composition, of an amphiphile compound of formula (II): 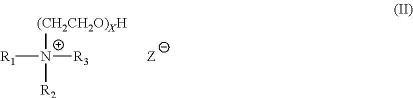
wherein R¹ is C₆-C₂₂ alkyl, branched or unbranched; R² is hydrogen, methyl, ethyl, or —(CH₂CH₂O)_{y}, wherein y is from 1 to 20; R³ is hydrogen, methyl, or ethyl; x is from 1 to 20; and Z is an anionic counterion; and
c) a perfume oil.

2. The composition according to claim 1, wherein said fabric softener active is a bis-(2-hydroxyethyl)-dimethylammonium chloride fatty acid ester, and wherein said fabric softener active is present from about 3% to about 15%, by weight of the fabric softener composition.

3. The composition according to claim 1, wherein said amphiphile compound is present from about 0.5% to about 0.9%, by weight of the fabric softener composition.

4. The composition according to claim 1, wherein said perfume oil is present from about 0.5% to about 5% by weight of the fabric softener composition.

5. The composition according to claim 1, wherein in formula (II), R¹ is C₆ to C₁₈ alkyl, branched or unbranched; R² is —(CH₂CH₂O)_{y}, wherein y is from 2 to 10; R³ is methyl; X is from 2 to 10; and Z is chloride.

6. The composition according to claim 1, further comprising an adjunct ingredient selected from the group consisting of a sulfur-containing pro-perfume compound, a perfume microcapsule (PMC), a polyol, a rheology modifier, and a combination thereof.

7. The composition according to claim 6, wherein said adjunct ingredient is a sulfur-containing pro-perfume compound, said sulfur-containing pro-perfume is selected from the group consisting of 3-(dodecylthio)-1-(2,6,6-trimethylcyclohex-3-en-1-yl)-1-butanone, 4-(dodecylthio)-4-(2,6,6-trimethylcyclohex-2-en1-yl)-2-butanone, 4-(dodecylthio)-4-(2,6,6-trimethylcyclohex-1-en-1-yl)-2-butanone, 3-(dodecylthio)-5-isopropenyl-2-methylcyclohexanone, and a combination thereof.

8. The composition according to claim 1, comprising:
a) from about 8% to about 11%, by weight of the fabric softener composition, of a bis-(2-hydroxyethyl)-dimethylammonium chloride fatty acid ester;
b) from about 0.5% to about 0.9%, by weight of the fabric softener composition, of a amphiphile compound of formula (I): 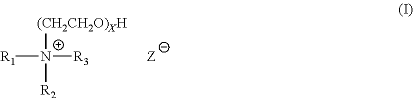
wherein R¹ is C₆-C₂₂ alkyl, branched or unbranched; R² is hydrogen, methyl, ethyl, or —(CH₂CH₂O)_{y}, wherein y is from 1 to 20; R³ is hydrogen, methyl, or ethyl; x is from 1 to 20; and Z is an anionic counterion; and
c) from about 3% to about 3.5%, by weight of the fabric softener composition, of a perfume oil.

9. The composition according to claim 8, further comprising:
d) from about 0.01% to about 3%, by weight of the fabric softener composition, of 3-(dodecylthio)-5-isopropenyl-2-methylcyclohexanone;
e) from about 0.1% to about 5%, by weight of the fabric softener composition, of a PMC;
f) from about 3% to about 7%, by weight of the fabric softener composition, of a glycerol; and
g) from about 0.01% to about 1%, by weight of the fabric softener composition, of a poly(acrylic acid).

10. A process of making the fabric softener composition according to claim 1, comprising the steps of:
i) providing a fabric softener active composition comprising from about 3% to about 50%, by weight of said fabric softener active composition, of said fabric softener active;
ii) adding said perfume oil and said amphiphile compound separately to said fabric softener active composition,
thereby making the fabric softener composition.

11. A process of making the fabric softener composition according to claim 1, comprising the steps of:
i) providing a fabric softener active composition comprising from about 3% to about 50%, by weight of said fabric softener active composition, of said fabric softener active;
ii) mixing said perfume oil and said amphiphile compound to form a mixture; and
iii) adding said mixture obtained in step ii) to said fabric softener active composition, thereby making the fabric softener composition.
